(19) United States
(12) Patent Application Publication
(10) Pub. No.: US 2021/0285730 A1
(43) Pub. Date: Sep. 16, 2021

(54) UNDERGROUND BUFFER STORAGE DEVICE AND METHOD FOR BUFFER STORAGE IN A HEAT STORAGE MEDIUM

(71) Applicant: TPLK Holding GmbH, Wien (AT)

(72) Inventors: Nikolai N. KORPAN, Wien (AT); Johann LEDOLTER, Wien (AT); Volodymyr G. PALANT, Kyiv (UA); Helmut TACHO, Wien (AT)

(73) Assignee: TPLK Holding GmbH, Wien (AT)

(21) Appl. No.: 17/198,532

(22) Filed: Mar. 11, 2021

(30) Foreign Application Priority Data
Mar. 11, 2020 (EP) 20162379.0

(51) Int. Cl. F28D 20/00

(52) U.S. Cl. CPC F28D 20/0043; F28D 2020/0078

(57) ABSTRACT

A buffer storage device and method including an underground storage chamber filled with a brine as a heat storage medium, a primary circuit filled with a first heat transfer medium, and a secondary circuit filled with a second heat transfer medium. A first heat exchanger in the primary circuit, through which the first heat transfer medium flows, is set up so as to transfer excess heat fed into the primary circuit from the first heat transfer medium to the brine in the underground storage chamber. A second heat exchanger in the secondary circuit, through which the second heat transfer medium flows, is set up so as to transfer, as required, at least some of the excess heat stored in the brine in the underground storage chamber to the second heat transfer medium. The secondary circuit is coupled to at least one heat consumer load.

### TECHNICAL FIELD

The invention relates to an underground buffer storage device for heat storage, and a method for the buffer storage of heat in an underground buffer storage device filled with a heat storage medium.

### BACKGROUND

### Background Information

Various forms of embodiment of heat storage devices that serve to temporarily store or buffer excess thermal energy are already of known prior art.

A buffer in a heating system is usually understood to be a heat storage tank that is filled with water. It is used to compensate for differences between the heat generated and the heat consumed in order to decouple heat generation from consumption over time. This improves the operational performance, efficiency and durability of many heat generators. For the operation of heat pumps, a buffer tank is not absolutely necessary, but it does improve the annual performance factor. In particular, the use of buffer storage for heat pumps can improve the load balancing potential of heat pumps in the electricity grid.

District heat storage tanks are usually unpressurised tanks filled with water that are intended to compensate for fluctuations in the heat demand of the district heating network while the generation performance of the district heating plants remains the same. In district heating networks, very large district heating storage tanks with volumes of several 100 m³ or even several 1000 m³ are generally used to temporarily store or buffer excess heat.

The disadvantage here is at least the continuous heat loss that results from the temperature difference between the contents of the storage tank and the environment. The loss can be reduced by thermal insulation (avoiding thermal bridges). In order to temporarily store larger amounts of excess thermal energy, for example in buffer storage tanks filled with water, large storage tanks are required, which must be insulated at very considerable expense in order to reduce heat losses as much as possible. However, such storage tanks are expensive to build, are maintenance-intensive, and require a lot of space.

Seasonal fluctuations in consumption and limited sources of natural fuel supply often make it necessary to search for unconventional methods of generating and storing thermal energy.

### SUMMARY

The invention aims at overcoming the disadvantages of conventional heat storage devices known from the prior art as far as possible, and at providing a buffer storage device for large amounts of excess heat, which is inexpensive to construct and operate while requiring little space, has low heat losses to the environment, and with which it is possible to smooth seasonal fluctuations in the consumption of required thermal energy, for example for the heating of buildings. With the aid of the heat storage device in accordance with the invention, it should be possible to ensure, for example, the heating of, the hot water supply to, or the air conditioning of, buildings.

In accordance with the invention, a buffer storage device comprises an underground storage chamber filled with a heat storage medium in the form of a brine, a primary circuit filled with a first heat transfer medium, and a secondary circuit filled with a second heat transfer medium, wherein a first heat exchanger in the primary circuit, through which the first heat transfer medium flows, is set up so as to transfer excess heat fed into the primary circuit from the first heat transfer medium to the brine in the underground storage chamber, and a second heat exchanger in the secondary circuit, through which the second heat transfer medium flows, is set up so as to transfer, as required, at least some of the excess heat stored in the brine in the underground storage chamber to the second heat transfer medium, wherein the secondary circuit is coupled to at least one heat consumer load.

An underground storage chamber to hold the heat storage medium offers numerous advantages. In such an underground storage chamber, the surrounding rock or soil serves as thermal insulation. Heat losses from the storage chamber can thus be reduced particularly efficiently. The space requirement of such an underground storage chamber is also very small. In the buffer storage device in accordance with the invention, only the primary circuit and the secondary circuit protrude up to the ground surface. All other components of the buffer storage device can expediently be installed underground. The primary circuit is used to feed excess heat, for example in the form of waste heat from industrial production, into the heat storage medium. For this purpose, the primary circuit comprises appropriate pipework, in which a first heat transfer medium can be pumped through the circuit, as well as a first heat exchanger in the primary circuit, through which the first heat transfer medium flows, and which is set up so as to transfer excess heat fed into the primary circuit from the first heat transfer medium to the brine in the underground storage chamber. The excess heat, or waste heat, can be fed into the primary circuit, for example, by the interposition of a further heat exchanger. For this purpose, the first heat exchanger is coupled in a heat-conducting manner to the storage chamber, that is to say, to the heat storage medium in the form of a brine located therein.

The secondary circuit also comprises appropriate pipework in which a second heat transfer medium can be pumped through the circuit. Furthermore, the secondary circuit comprises a second heat exchanger, through which the second heat transfer medium flows, and which is provided for the purpose of transferring, as required, at least some of the excess heat stored in the brine in the underground storage chamber to the second heat transfer medium. For this purpose, the second heat exchanger is also coupled in a heat-conducting manner to the storage chamber, that is to say, to the heat storage medium in the form of a brine located therein.

Furthermore, the secondary circuit is coupled to at least one heat consumer load, to which the excess heat from the second heat transfer medium can be delivered, for example, with the interposition of a further heat exchanger.

The buffer storage device is advantageously a self-contained system with a self-contained storage chamber and the two likewise self-contained circuits, the primary circuit and the secondary circuit. The media contained therein, that is to say, the first heat transfer medium in the primary circuit, and the second heat transfer medium in the secondary circuit, do not come into direct contact with the heat storage medium, the brine, in the sense of a material exchange. The operation of the buffer storage device is therefore ecologically secure and there are no environmentally harmful emissions.

In summary, a particularly efficient heat storage of excess heat is possible with a buffer storage device in accordance with the invention.

In a preferred embodiment of the invention, the underground storage chamber of the buffer storage device can be a cavity in a water-impervious rock layer, preferably in a salt dome.

This embodiment offers the advantage that the costs for constructing the buffer storage device can be reduced accordingly by using an already existing underground cavity as the storage chamber. Such an underground cavity can be of natural origin—for example, an underground lake that has formed in a water-impervious rock layer such as a salt dome. Such a cavity can also have been artificially created, for example in a salt mine by appropriate leaching of the salt-bearing rock. Furthermore, the salt-bearing rock of a salt dome offers the advantage of a particularly good heat storage action, that is to say, very good heat insulation. The heat losses of the buffer storage device in an underground salt dome are significantly lower compared to heat losses in commonplace, non-salt-bearing rock.

The combination of the arrangement of the underground storage chamber in a cavity in a water-impervious rock layer, preferably in a salt dome, with the use of a brine as a buffer storage medium, also offers the advantage that the rock, in particular a salt-bearing rock, is no longer leached out further, or at least only to an acceptably low extent, by the buffer storage medium.

The system of the underground buffer storage device proposed here in accordance with the invention, with a brine as the buffer storage medium, which is located in an underground storage chamber in the form of a cavity in a water-impervious rock, preferably in a salt dome, offers the advantage that a solubility equilibrium is quickly formed between the rock material in which the cavity is located and the brine as the buffer storage medium.

The underground cavity is not subject to any restrictions in its dimensions or geometry. Thus, a cavity of any shape, contour and form can serve as an underground storage chamber. Likewise, a plurality of cavities, or hollow spaces, connected to each other in a communicating manner, can form the individual storage chambers of an entire underground storage system.

It can be particularly expedient if, in a buffer storage device in accordance with the invention, the brine is an aqueous solution of salts with at least 14 g of dissolved substances per 1 litre of water.

In a further development of the invention, the brine in a buffer storage device can contain sodium chloride in a dissolved form.

Sodium chloride, also known as cooking salt, can be extracted from rock salt from underground salt deposits, for example, by leaching with water from the ground surface. In addition, cooking salt can be obtained from sea salt, amongst other sources.

As already noted earlier, the use of a brine as a heat storage medium containing sodium chloride in a dissolved form offers the advantage that a solubility equilibrium is quickly established in an underground storage chamber located in a water-impervious rock layer, preferably in a salt-bearing rock layer in a salt dome. Thus, any changes in the underground storage chamber as a result of undesired leaching, or the dissolution of water-soluble rock constituents, in particular salt, are prevented.

In a further development of the invention, the brine in a buffer storage device can comprise sodium chloride in a dissolved form at a concentration of from 2% to 30% by weight, preferably from 10% to 30% by weight, particularly preferably from 20% to 30% by weight.

For the reasons cited above, the use of a brine with a higher concentration of sodium chloride is advantageous, in that a solubility equilibrium is quickly established between the brine and the rock that forms the underground storage chamber. Furthermore, the use of a brine with a higher salt concentration is advantageous, since this increases the heat storage capacity, and the heat storage capability is increased in comparison to that of water.

At most, the concentration of the brine can be increased until the solubility of sodium chloride in water is reached. The solubility of sodium chloride in water is only slightly dependent on temperature and is, for example, 359 g/litre of the brine at a temperature of 20° C. (° Celsius). This corresponds to a maximum mass concentration, or mass fraction, of 26.4% by weight at 20° C.

It can be advantageous if, in a buffer storage device in accordance with the invention, the brine contains potassium chloride in a dissolved form.

The above-cited advantages apply equally to brines containing sodium chloride, those containing potassium chloride, or mixtures of both salts, optionally with other dissolved salts.

In a further development of the invention, the brine in a buffer storage device can contain potassium chloride in a dissolved form at a concentration of from 2% to 30% by weight, preferably from 10% to 30% by weight, particularly preferably from 20% to 30% by weight.

The concentration of the brine can be increased to a maximum at which the solubility of potassium chloride in water is reached. The solubility of sodium chloride in water is only slightly dependent on temperature and is, for example, 347 g/litre of the brine at a temperature of 20° C.

In a buffer storage device in accordance with the invention, the first heat transfer medium of the primary circuit can particularly expediently be selected from the group: water, alcohol-water solution, salt-water solution, thermal oil.

Advantageously, a wide variety of media can be deployed as the first heat transfer medium within the scope of the invention, depending on the assignment and the temperature level of the excess heat to be buffered. Heat transfer media should ideally meet the following requirements: they should have a high specific heat capacity, that is to say, a large specific melting enthalpy, a high heat transfer coefficient, a high thermal conductivity, a freezing point, that is to say, a solidification point, that is as low as possible, a sufficiently high boiling point and, if possible, a low viscosity. Advantageously, heat transfer media are non-flammable, non-explosive, and non-toxic.

Water is a very good heat transfer medium by virtue of its very high specific heat capacity of about 4.2 kJ/kg K and its high specific evaporation enthalpy of about 2000 kJ/kg.

Heat transfer media consisting of water and alcohol are advantageously non-corrosive or are only slightly corrosive.

Salt-water solutions (brines) can also be deployed in food technology. The viscosity of salt-water solutions is low.

Thermal oils are used for oil cooling and for the heating of industrial plants and processes in closed circuits. They can have different properties depending on their chemical composition. They can be divided into low-viscosity, highly flammable oils with low solidification and boiling points, and higher-viscosity, only slightly flammable oils with higher solidification and boiling points. Mineral oils, synthetic oils such as silicone oil, aromatic hydrocarbons (for example DP/DPO), or biological oils (for example limonene) belong, for example, to the group of thermal oils.

In another expedient embodiment of the invention, in a buffer storage device, the second heat transfer medium of the secondary circuit can be selected from the group consisting of: water, alcohol-water solution, ammonia, carbon dioxide, hydrocarbons, halogenated hydrocarbons.

Depending on the assignment, different media can be deployed as a second heat transfer medium. If necessary, coolants or refrigerants can also be deployed as a second heat transfer medium. Ammonia, carbon dioxide and water, but also hydrocarbons and air are, in contrast to halogenated hydrocarbons, also referred to as natural refrigerants, as these substances occur in nature. Refrigerants transport enthalpy—that is to say, thermal energy—from an object to be cooled to the environment. The difference from a coolant is that a refrigerant can do this along a temperature gradient in a refrigeration cycle, so that the ambient temperature can even be higher than the temperature of the object to be cooled, whereas a coolant is only able in a cooling cycle to transport enthalpy against the temperature gradient to a point of lower temperature.

Ammonia is a traditional climate-neutral refrigerant that is mainly used in large industrial plants.

Carbon dioxide has a very large volumetric refrigeration capacity, so the volume of circulating refrigerant is relatively small. Carbon dioxide also has the advantage of being non-flammable, and does not contribute to ozone depletion.

Furthermore, organic refrigerants such as dichlorodifluoromethane (R-12; Freon-12®) can also be deployed as a second heat transfer medium. Halocarbons or halogenated hydrocarbons are hydrocarbons in which at least one hydrogen atom has been replaced by one of the halogens fluorine, chlorine, bromine or iodine. By virtue of their properties, halogenated hydrocarbons are ideally suited as refrigerants. However, it should be noted that due to their environmentally harmful properties, they can only be deployed in closed-loop systems.

A method in accordance with the invention for the buffer storage of excess heat in a heat storage medium is characterised by the following steps:
Feeding of excess heat to be stored into a primary circuit filled with a first heat transfer medium;
Transfer of the excess heat by means of a first heat exchanger arranged in the primary circuit, through which the first heat transfer medium flows, to an underground storage chamber filled with a brine as the heat storage medium;
Intermediate storage of the excess heat in the brine of the underground storage chamber;
Removal, as required, of at least some of the excess heat temporarily stored in the brine by transfer of the excess heat from the brine to the second heat transfer medium, by means of a second heat exchanger arranged in a secondary circuit, and through which a second heat transfer medium flows;
Discharge of the excess heat to at least one heat consumer load coupled to the secondary circuit.

A buffer storage device in accordance with the present disclosure is advantageously deployed in the buffer storage method in accordance with the invention.

With regard to the advantages of the buffer storage method, reference is made to the above-cited advantages of the buffer storage device in accordance with the invention.

In a further development of the buffer storage method in accordance with the invention, it can be expedient if the primary circuit with the first heat exchanger and the secondary circuit with the second heat exchanger are each coupled in a heat-conducting manner to the underground storage chamber and the brine located therein.

The primary circuit and the secondary circuit are advantageously connected to the underground storage chamber in a heat-conducting manner. Corresponding heat exchangers, which are arranged in the primary circuit and in the secondary circuit, transfer the excess heat directly to the brine, or, as required, transfer the buffered excess heat again to the secondary circuit.

It can be particularly advantageous if, in a buffer storage method in accordance with the invention, the underground storage chamber is arranged in a cavity in a water-impervious rock layer, preferably in a salt dome, and the first heat transfer medium is led through pipework of the primary circuit, and the second heat transfer medium is led through pipework of the secondary circuit, in each case from the ground surface to the storage chamber, and back to the ground surface.

As already noted earlier, the use of existing underground cavities as storage chambers is particularly sustainable for the operation of the buffer storage method.

In a buffer storage method in accordance with the invention, an aqueous solution of salts with at least 14 g of dissolved substances per 1 litre of water can expediently be deployed as the brine.

It can be advantageous if, in a buffer storage method in accordance with the invention, the brine contains sodium chloride and/or potassium chloride in a dissolved form.

In a further development of the buffer storage method in accordance with the invention, the brine can contain sodium chloride and/or potassium chloride in a dissolved form at a concentration of from 2% to 30% by weight, preferably from 10% to 30% by weight, particularly preferably from 20% to 30% by weight.

The above-mentioned advantages apply equally to brines containing sodium chloride, those containing potassium chloride, or mixtures of both salts, optionally with other dissolved salts.

### BRIEF DESCRIPTION OF THE SEVERAL VIEWS OF THE DRAWINGS

FIG. 1 is a schematic cross sectional side view of a buffer storage device in accordance with the present disclosure.

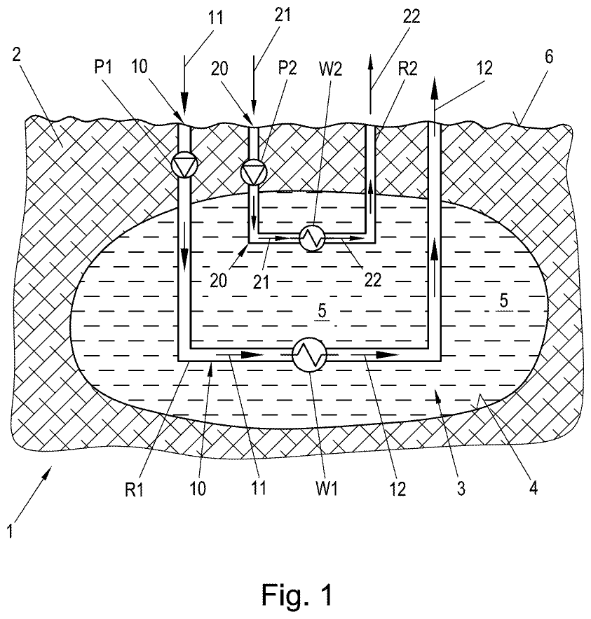

### DETAILED DESCRIPTION

In what follows the accompanying FIGURE is described in detail.

The FIGURE shows in a schematic cross-sectional side view a buffer storage device 1 in accordance with the invention, wherein here, within a rock layer 2, an underground cavity 3 is used as an underground storage chamber 3, as a storage container for a heat storage medium. A contour 4 of the underground storage chamber 3, that is to say, the underground cavity 3, forms the boundary between the cavity 3 and the surrounding rock 2. The storage chamber 3, or cavity 3, is filled with a brine 5 as a heat storage medium. The underground storage chamber 3 is located entirely below the ground surface 6. A primary circuit 10 and a secondary circuit 20 are only sketched in the FIGURE to the extent that the corresponding components of the two circuits 10, 20 are also arranged underground.

In the primary circuit 10, a hot first heat transfer medium 11, which was previously charged with excess heat, or waste heat, for example from an industrial operation, is pumped through pipework R1 of the primary circuit 10 in the direction of the arrow 11, by means of a pump P1, in the direction of the underground storage chamber 3. The industrial operation in which the excess heat there present was fed into the primary circuit 10, for example by means of a further heat exchanger, or heat transfer device, is not illustrated in the FIGURE. The apparatus and components required for feeding the excess heat into the first heat transfer medium 11 within the primary circuit 10, such as a further heat exchanger, are also not explicitly shown, but are adequately familiar to the person skilled in the art. The hot first heat transfer medium 11 is thus pumped within the pipework R1 to a heat exchanger W1 of the primary circuit 10, through which the first heat transfer medium flows. In the heat exchanger W1, the excess heat is transferred to the brine 5 as a heat storage medium in the underground storage chamber 3, that is to say, delivered to the latter, whereby the first heat transfer medium cools down and returns to the ground surface as a comparatively cold first heat transfer medium 12 in the primary circuit 10. As mentioned earlier, the primary circuit 10 and the secondary circuit 20 described below are in each case closed circuits, which for simplicity are shown exposed in the FIGURE in the region of the level of the ground surface 6. In actual fact, the cold first heat transfer medium 12, symbolised in the FIGURE by an arrow 12, and apparently emerging from the ground surface 6, and also the hot first heat transfer medium 11, symbolised by an arrow 11, continue to be located within the closed pipework R1 of the primary circuit 10. The cold first heat transfer medium 12 can in turn be charged with excess heat, or waste heat, for example from an industrial operation, in order to serve again as the hot first heat transfer medium 11 for purposes of heating the brine 5 in the storage chamber 3.

Advantageously, the storage chamber 3 is very well thermally insulated by virtue of the surrounding rock 2, which is why heat losses during buffer storage can be reduced.

A separate secondary circuit 20 contains a second heat transfer medium, which serves to remove, that is to say, deplete, the heat buffered in the storage chamber 3. In an analogous manner to the structure of the primary circuit 10, the secondary circuit 20 also comprises a pump P2, pipework R2 and a heat exchanger W2. The arrow 21 symbolises the cold second heat transfer medium 21, which is pumped in the direction of the arrow 21 in the secondary circuit 20 within the pipework R2 towards the underground storage chamber 3. Buffered excess heat is transferred in the heat exchanger W2 from the previously heated brine 5 inside the storage chamber 3 to the cold second heat transfer medium 21 that flows through the heat exchanger W2. Through appropriate heat transfer, at least some of the excess heat is transferred to the second heat transfer medium, which is thereby heated. The arrow 22 symbolises the heated, that is to say, hot, heat transfer medium 22, which then travels upwards within the secondary circuit 20 to the ground surface 6, and there—still located within the pipework R2—transfers the absorbed buffered heat to a heat consumer load coupled to the secondary circuit 20. The heat consumer load, for example a heating system of a building, as well as the apparatus and equipment required for heat removal, such as a further heat exchanger, are not illustrated in the FIGURE for the sake of simplicity. The second heat transfer medium is cooled down accordingly, and is again available within the closed secondary circuit 20 for the absorption of heat as a cooled, that is to say, cold, second heat transfer medium 21.

### LIST OF REFERENCE SYMBOLS

1 Buffer storage device

2 Rock

3 Underground storage chamber, cavity

4 Contour of the underground storage chamber or cavity

5 Brine

6 Ground surface

10 Primary circuit

11 Hot heat transfer medium of the primary circuit (arrow)

12 Cold heat transfer medium of the primary circuit (arrow)

P1 Pump in the primary circuit

R1 Pipework of the primary circuit

W1 Heat exchanger of the primary circuit

20 Secondary circuit

21 Cold heat transfer medium of the secondary circuit (arrow)

22 Hot heat transfer medium of the secondary circuit (arrow)

P2 Pump in the secondary circuit

R2 Pipework of the secondary circuit

W2 Heat exchanger of the secondary circuit

1. A buffer storage device, comprising:
an underground storage chamber filled with a brine as a heat storage medium:
a primary circuit filled with a first heat transfer medium;
a secondary circuit filled with a second heat transfer medium;
a first heat exchanger provided in the primary circuit and through which the first heat transfer medium flows, wherein the first exchanger is set up so as to transfer excess heat fed into the primary circuit from the first heat transfer medium to the brine in the underground storage chamber; and
a second heat exchanger provided in the secondary circuit and through which the second heat transfer medium flows, wherein the second heat exchanger is set up so as to transfer, as required, at least some of the excess heat stored in the brine in the underground storage chamber to the second heat transfer medium; and
wherein the secondary circuit is coupled to at least one heat consumer load.

2. The buffer storage device according to claim 1, wherein the underground storage chamber is a cavity in a water-impervious rock layer.

3. The buffer storage device according to claim 1, wherein the brine is an aqueous solution of salts with at least 14 g of dissolved substances per 1 litre of water.

4. The buffer storage device according to claim 1, wherein the brine contains sodium chloride in a dissolved form.

5. The buffer storage device according to claim 4, wherein the brine contains sodium chloride in a dissolved form, with a concentration of from 2% to 30% by weight.

6. The buffer storage device according to claim 1, wherein the brine contains potassium chloride in a dissolved form.

7. The buffer storage device according to claim 6, wherein the brine contains potassium chloride in a dissolved form with a concentration of from 2% to 30% by weight.

8. The buffer storage device according to claim 1, wherein the first heat transfer medium of the primary circuit is one of water, alcohol-water solution, salt-water solution, and thermal oil.

9. The buffer storage device according to claim 1, wherein the second heat transfer medium of the secondary circuit is one of water, alcohol-water solution, ammonia, carbon dioxide, hydrocarbons, and halogenated hydrocarbons.

10. A method for a buffer storage of excess heat in a heat storage medium, comprising steps of:
feeding of excess heat to be stored into a primary circuit filled with a first heat transfer medium;
transfer of the excess heat with a first heat exchanger arranged in the primary circuit, through which the first heat transfer medium flows, to an underground storage chamber filled with a brine as a heat storage medium;
intermediate storage of the excess heat in the brine of the underground storage chamber;
removal, as required, of at least some of the excess heat temporarily stored in the brine, by transfer of the excess heat from the brine to a second heat transfer medium, by means of a second heat exchanger arranged in a secondary circuit, and through which a second heat transfer medium flows; and
discharge of the excess heat to at least one heat consumer load coupled to the secondary circuit.

11. The buffer storage method according to claim 10, wherein the primary circuit with the first heat exchanger and the secondary circuit with the second heat exchanger, are in each case coupled in a heat-conducting manner to the underground storage chamber and to the brine located therein.

12. The buffer storage method according to claim 10, wherein the underground storage chamber is arranged in a cavity in a water-impervious rock layer, and the first heat transfer medium in pipework of the primary circuit, and the second heat transfer medium in pipework of the secondary circuit, are in each case led from a ground surface to the storage chamber and back to the ground surface.

13. The buffer storage method according to claim 10, wherein an aqueous solution of salts with at least 14 g of dissolved substances per 1 litre of water is deployed as the brine.

14. The buffer storage method according to claim 10, wherein the brine contains sodium chloride and/or potassium chloride in a dissolved form.

15. The buffer storage method according to claim 14, wherein the brine contains sodium chloride and/or potassium chloride in a dissolved form, with a concentration of 2% to 30% by weight.

16. The buffer storage device according to claim 2, wherein the cavity is in a salt dome.

17. The buffer storage device according to claim 5, wherein the brine contains sodium chloride in a dissolved form, with a concentration of from 10% to 30% by weight.

18. The buffer storage device according to claim 7, wherein the brine contains potassium chloride in a dissolved form with a concentration of from 10% to 30% by weight.

19. The buffer storage method according to claim 12, wherein the underground storage chamber is arranged in a cavity in a salt dome.

20. The buffer storage method according to claim 15, wherein the brine contains sodium chloride and/or potassium chloride in a dissolved form with a concentration of from 10% to 30% by weight.
